(19) United States
(12) Patent Application Publication
(10) Pub. No.: US 2008/0088695 A1
(43) Pub. Date: Apr. 17, 2008

(54) Video Camera Stand With Video Server Function

(75) Inventors: Fan-Sheng Lin, Taipei (TW); Sung-Chin Shen, Taipei (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: ETROVISION TECHNOLOGY, Taipei (TW)

(21) Appl. No.: 11/620,666

(22) Filed: Jan. 6, 2007

(30) Foreign Application Priority Data
Oct. 13, 2006 (TW) 095137778

(51) Int. Cl. H04N 7/14

(52) U.S. Cl. 348/14.08

(57) ABSTRACT

A video camera stand with a video server function is provided, which is used for joining with a video camera. The video camera stand includes a stand body, a base, and a network video server module disposed in the stand body, and furthermore, the video camera stand and the video camera share a single power supply wiring, without additionally connecting to a different power supply.

### CROSS-REFERENCE TO RELATED APPLICATIONS

This non-provisional application claims priority under 35 U.S.C. § 119(a) on Patent Application No(s). 095137778 filed in Taiwan, R.O.C. on Oct. 13, 2006, the entire contents of which are hereby incorporated by reference.

### BACKGROUND OF THE INVENTION

1. Field of Invention

The present invention relates to a video camera stand, and more particularly, to a video camera stand with a video server function.

2. Related Art

As the rapid development of Internet technology, the network video surveillance system has been widely used in airport, financial departments, luxury apartment community management, nuclear power plant, military database, etc. In the conventional network remote surveillance system, a video surveillance node usually achieves the aim of digital compression and transmission by using network video servers and network video cameras.

Please refer to FIG. 1 of a systematic architecture view of a conventional network remote surveillance system 10. As shown in FIG. 1, the network remote surveillance system generally uses a network video server 20 together with a video camera 30 or a network video camera 40 to digitize and networkize a video data of a remote video surveillance node through a local area network (LAN)/Internet 50, and then transfer to a central management system 60 for the manager to monitor the environmental change around the location of the network video server 20 and the network video camera 40 in a real time, and to record the received video data for further applications.

Please refer to FIG. 2 of a structural schematic view of the network video server 20 in FIG. 1. As shown in FIG. 2, the network video server 20 must be externally connected to at least one video camera 30 to monitor the video in an environment to be monitored in real time. Generally, the video camera 30 is mounted in a preset position within the environment to be monitored by a fixing stand 32. The network video server 20 mainly includes a TV decoder 21, a video compression unit 23, a CPU 25, and a network interface 27. Moreover, the network video server 20 is mounted in a certain preset position of the environment to be monitored by a fixing device 22, which is usually a position that is independent from the video camera 30 (usually on the ceiling or in the electric distribution cabinet around the surveillance node). The network video server 20 and the video camera 30 are respectively connected to power supplies 24, 34.

When the network remote surveillance system 10 is operated, the video camera 30 transfers the TV video signal (such as an NTSC signal) captured by the video surveillance node to the TV decoder 21. The TV decoder 21 transforms the above analog TV video signal into a digital video signal (such as an ITU-656 signal), and then transfers to the video compression unit 23. Then, the video compression unit 23 performs a digital video compression process (such as JPEG) on the above digital video signal, and then transfers to the CPU 25 for transforming the above digital video compression signal into a packet that conforms to the network protocol. Finally, a network interface 27 is used to transfer the packed signal to a central management system 60 over LAN/Internet 50.

Please refer to FIG. 3 of a structural schematic view of the network video camera 40 in FIG. 1. As shown in FIG. 3, the network video camera 40 includes a video camera module 41, a video compression unit 43, a CPU 45, and a network interface 47. Moreover, the video camera 40 is mounted in a certain preset position of an environment to be monitored via a fixing stand 42.

When the network remote surveillance system 10 is operated, the video camera module 41 transforms the TV video signal captured by the video surveillance node into a digital video signal (such as an ITU-656 signal) and then transfers to a video compression unit 43. Then, the video compression unit 43 performs a digital video compression process (such as JPEG) on the above digital video signal, and then transfers to the CPU 45 for transforming the above digital video compression signal into a packet that conforms to the network protocol. Finally, a network interface 47 is used to transfer the packed signal to a central management system 60 over the LAN/Internet 50.

Although the conventional network video server 20 is able to combine with the video camera 30 to transfer the video data to the LAN/Internet 50, the network video server 20 and the video camera 30 must be mounted and fixed independently, thus, the process of mounting and wiring is very complicated, and they are connected to different power supplies 24, 34, which is inconvenient for being used.

Moreover, although the network video camera 40 has the video camera module 41 being built-in, which has the advantages of being easy for mounting and wiring, however, when the system installer needs to use different kinds of video cameras and lens to match with different monitored environments (e.g., a surveillance node requires a specialized video camera at low illumination level), the video camera of the network video camera is a built-in video camera, which cannot provide the installer with sufficient flexibility as the network video server 20, thus, the user's requirements in real application are not satisfied.

### SUMMARY OF THE INVENTION

In view of the above problems, a main object of the present invention is to provide a video camera stand with a video server function, which is combined with a video camera to satisfy the user's requirements.

According to the above object, the present invention provides a video camera stand with a video server function, which is used for joining with a video camera. The video camera stand comprises a stand body opened with two through holes, a base used for carrying the stand body, and a network video server module mounted in the stand body. The network video server module comprises a power input terminal for being connected to a power supply line, a network connecting terminal for being connected to a network line, a power output terminal for being connected to a video camera via a power transmission line to transmit the electric power from an external power supply to the video camera, and a signal receiving terminal for being connected to the video camera via a signal transmission line to receive the video captured by the video camera. Moreover, the power transmission line and the signal transmission line respectively pass through the two through holes to connect to joints corresponding to the video camera.

The video camera stand with a video server function of the present invention can be combined with a video camera into a single device, thus, the video camera stand can be mounted in a single position within an environment to be monitored, and the video camera stand and the video camera share a single power supply wiring without additionally connecting to a different power supply. Moreover, the video camera stand with a video server function of the present invention has an environment parameter input unit and an alarm output unit, such that the remote surveillant is capable of mastering the change in the surrounding environment of the video camera stand, which thus satisfies the user's practical requirements.

Further scope of applicability of the present Invention will become apparent from the detailed description given hereinafter. However, it should be understood that the detailed description and specific examples, while indicating preferred embodiments of the Invention, are given by way of illustration only, since various changes and modifications within the spirit and scope of the Invention will become apparent to those skilled in the art from this detailed description.

### BRIEF DESCRIPTION OF THE DRAWINGS

The present Invention will become more fully understood from the detailed description given herein below for illustration only, and thus is not limitative of the present Invention, and wherein:

FIG. 1 is a systematic architecture view of a conventional network remote surveillance system;

FIG. 2 is a structural schematic view of the network video server in FIG. 1;

FIG. 3 is a structural schematic view of the network video camera in FIG. 1;

FIG. 4 is a structural schematic view of a video camera stand of the present invention; and

FIG. 5 is a schematic assembly view of the video camera stand of the present invention with a video camera.

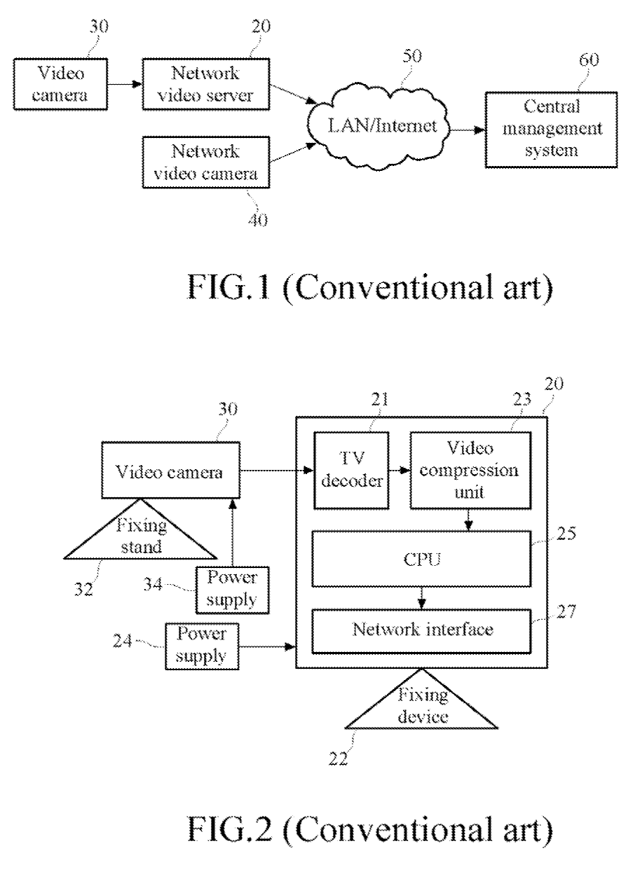

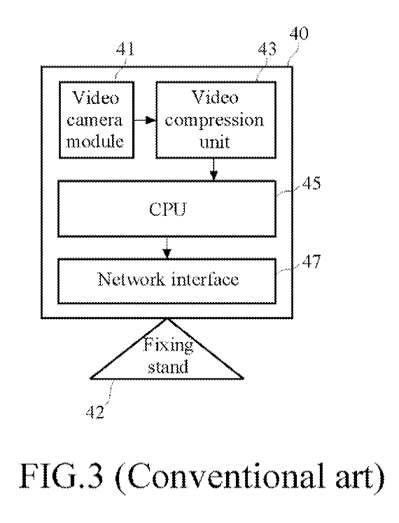

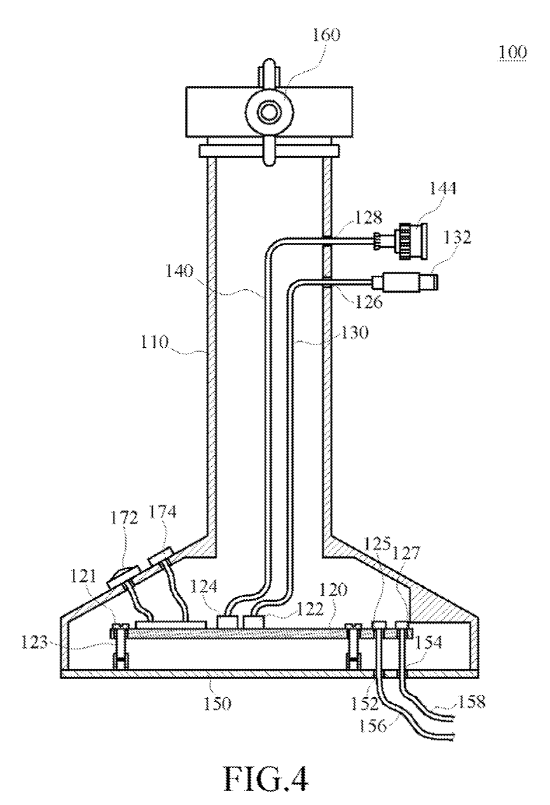

### DETAILED DESCRIPTION OF THE INVENTION

In order to describe the video camera stand with a video server function of the present invention in detail, the network video server module of the present invention is described below, by taking a conventional network video server as an example, thus, the detailed structure and composition thereof will not be described in detail.

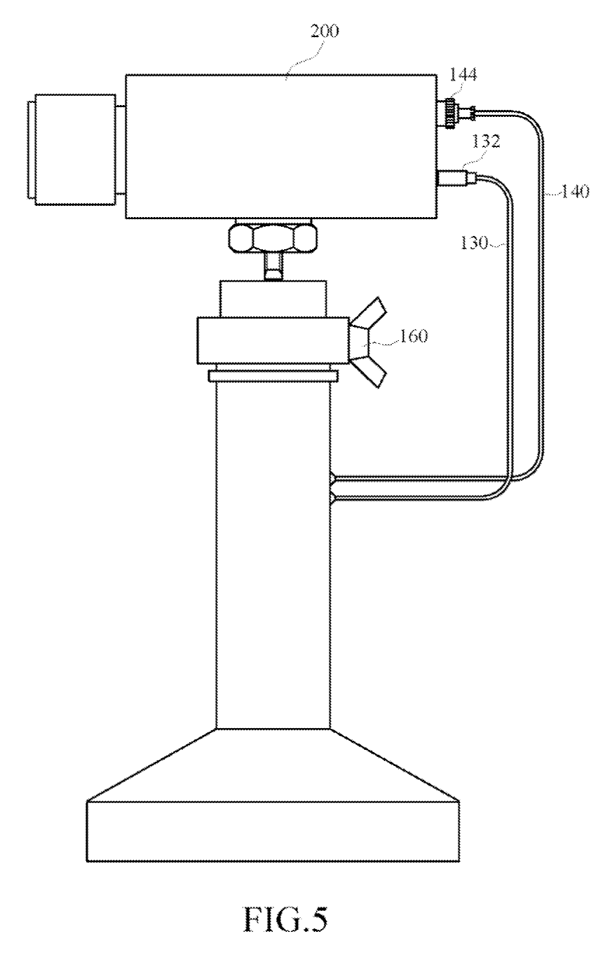

Please refer to FIGS. 4 and 5. FIG. 4 is a structural schematic view of a video camera stand of the present invention. FIG. 5 is a schematic assembly view of the video camera stand of the present invention with a video camera. As shown in FIGS. 4 and 5, the video camera stand 100 with a video server function of the present invention is used to be combined with a video camera 200. The video camera stand 100 includes a stand body 110 opened with two through holes 126 and 128, a base 150 used for carrying the stand body 110, and a network video server module 120 disposed in the stand body 110.

The network video server module 120 of the present invention has a plurality of fixing holes 121 disposed on the peripheral edge; and through a corresponding number of locking members 123, the network video server module 120 is fixed on the base 150. Definitely, the network video server module 120 of the present invention also can be fixed on the base 150 through other locking methods such as bonding and soldering, which do not depart from the scope of the present invention. The network video server module 120 includes a power input terminal 125, a network connecting terminal 127, a power output terminal 122, and a signal receiving terminal 124. Moreover, the base 150 is further opened with a power supply line hole 152 and a network line hole 154, which are respectively provided for a power supply line 156 and a network line 158 to pass through and to be connected to the power input terminal 125 and the network connecting terminal 127 of the network video server module 120, so as to provide the video camera stand 100 with the electric power and the network connecting function. Definitely, the base 150 also can be opened with only one through hole for the power supply line 156 and the network line 158 to pass through and to be connected to the power input terminal 125 and the network connecting terminal 127, which is not shown in the figure in detail.

Moreover, the power output terminal 122 of the network video server module 120 is connected to a power transmission line 130 that passes through the through hole 126 and is exposed out of the stand body 110. A power supply connector 132 is disposed on one end of the power transmission line 130 to join with the corresponding part of the video camera 200, so as to provide the electric power demanded by the video camera 200.

Moreover, the signal receiving terminal 124 of the network video server module 120 is connected to a signal transmission line 140 that passes through the through hole 128 and is exposed out of the stand body 110, and a video connector 144 is disposed on an end of the signal transmission line 140 to be joined with the corresponding part of the video camera 200, for receiving the video captured by the video camera 200.

Moreover, the video camera stand 100 of the present invention further includes at least one environment parameter input unit 172 and at least one alarm output unit 174, which are mounted on the stand body 110. The environment parameter input unit 172 is used to detect the change in the surrounding environment of the video camera stand 100 and transfer the detected result to the network video server module 120. In the present embodiment, the environment parameter input unit 172 is a microphone used to transfer the sound parameters of the surrounding environment of the video camera stand 100 to the network video server module 120. The environment parameter input unit 172 also may be a motion sensor used to detect the speed or the acceleration parameters of the moving object in the surrounding environment of the video camera stand 100 and transfer them to the network video server module 120. The environment parameter input unit 172 may also a temperature sensor used to sense the temperature change in the surrounding environment of the video camera stand 100 (e.g., when a fire accident occurs, the environmental temperature rises) and transfer the result to the network video server module 120. The environment parameter input unit 172 also may be a smoke sensor used to detect the smoke particles change in the surrounding environment of the video camera stand 100 (e.g., when a fire accident occurs, the increasing of the smoke particles in the environment can be detected) and transfer the detected result to the network video server module 120. Therefore, the environment parameter input unit 172 transfers the detected parameters corresponding to the surrounding environment of the video camera stand 100 to the video server module 120, and then transmits to a remote control system via the network line 158, thus, the situation of the surrounding environment of the video camera stand 100 is known by the user.

The alarm output unit 174 may be a speaker, a buzzer, or a display lamp (e.g., LED), which has the function of outputting an alarm to the surrounding environment of the video camera stand 100 through the network video server module 120.

When the video camera 200 is to be assembled with the video camera stand 100 of the present invention, the video camera 200 is simply disposed onto the video camera stand 100, and then, the video camera 200 is locked onto the video camera stand 100 through a video camera fixing device 160 disposed on the video camera stand 100 (e.g., the video camera 200 is locked by rotating the video camera fixing device 160 in a clockwise direction, and the video camera 200 is released by rotating the video camera fixing device 160 in a counterclockwise direction), thus, the process of assembling the video camera stand 100 with the video camera 200 having a video server function of the present invention is accomplished.

In comparison with the conventional art, the video camera stand 100 with a video server function of the present invention may be combined with the video camera 200 into a single device, such that the video camera stand 100 is only needed to be mounted at a single position within the environment to be monitored, and the video camera stand 100 and the video camera 200 share a single power supply wiring, without additionally connecting to a different power supply. Moreover, the video camera stand 100 with a video server function of the present invention has the environment parameter unit 172 and the alarm output unit 174, which enable a remote surveillant to master the change in the surrounding environment of the video camera, thereby satisfying the user's practical requirements.

The invention being thus described, it will be obvious that the same may be varied in many ways. Such variations are not to be regarded as a departure from the spirit and scope of the Invention, and all such modifications as would be obvious to one skilled in the art are intended to be included within the scope of the following claims.

What is claimed is:

1. A video camera stand with a video server function, used for joining with a video camera, comprising:
a stand body opened with two through holes;
a base for carrying the stand body; and
a network video server module mounted in the stand body, comprising:
a power input terminal connected to a power supply line;
a network connecting terminal connected to a network line;
a power output terminal connected to the video camera via a power transmission line, for transferring an electric power from an external power supply to the video camera; and
a signal receiving terminal connected to the video camera via a signal transmission line, for receiving the video captured by the video camera;
wherein the power transmission line and the signal transmission line respectively pass through the two through holes to be connected to joints corresponding to the video camera.

2. The video camera stand with a video server function as claimed in claim 1, further comprising a video camera fixing device, disposed on the stand body for locking the video camera.

3. The video camera stand with a video server function as claimed in claim 1, wherein one end of the power transmission line that is connected with the video camera is provided with a power connector for connecting to the joint corresponding to the video camera.

4. The video camera stand with a video server function as claimed in claim 1, wherein one end of the signal transmission line that is connected with the video camera is provided with a video connector for connecting to the joint corresponding to the video camera.

5. The video camera stand with a video server function as claimed in claim 1, wherein the network video server module further comprises a plurality of fixing holes formed on the peripheral edge, and a corresponding number of locking members pass through the fixing holes, so as to lock the network video server module on the base.

6. The video camera stand with a video server function as claimed in claim 1, wherein the base further comprises a power supply line hole and a network line hole, which are respectively provided for the power supply line and the network line to pass through and to be connected to the power input terminal and the network connecting terminal.

7. The video camera stand with a video server function as claimed in claim 1, further comprising at least one environment input unit mounted on the stand body for detecting the change in the surrounding environment of the video camera stand and inputting the detected result into the network video server module.

8. The video camera stand with a video server function as claimed in claim 7, wherein the environment input unit is a microphone.

9. The video camera stand with a video server function as claimed in claim 7, wherein the environment input unit is a motion sensor.

10. The video camera stand with a video server function as claimed in claim 7, wherein the environment input unit is a temperature sensor.

11. The video camera stand with a video server function as claimed in claim 7, wherein the environment input unit is a smoke sensor.

12. The video camera stand with a video server function as claimed in claim 1, further comprising at least one alarm output unit mounted on the stand body for enabling the network video server module to have a function of outputting an alarm to the surrounding environment of the video camera stand.

13. The video camera stand with a video server function as claimed in claim 12, wherein the alarm output unit is a speaker.

14. The video camera stand with a video server function as claimed in claim 12, wherein the alarm output unit is a buzzer.

15. The video camera stand with a video server function as claimed in claim 12, wherein the alarm output unit is a display lamp.
